(19) United States
(12) Patent Application Publication
(10) Pub. No.: US 2025/0081988 A1
(43) Pub. Date: Mar. 13, 2025

(54) TEXTURED VEGETABLE PROTEIN

(71) Applicant: COÖPERATIE KONINKLIJKE AVEBE U.A., Veendam (NL)

(72) Inventors: Francesco FILIPPI, Groningen (NL); Gijsbert Theodorus FRANKE, Groningen (NL); Stevina Cornelia STOTER, Emmen (NL); Roelof Bernardus TER STEGE, Emmen (NL); Annet VRIELING, Oosterhesselen (NL); David Ignacio HABEYCH NARVAEZ, Groningen (NL); Didier Andre Pierre DELNOYE, Groningen (NL)

(21) Appl. No.: 18/713,810

(22) PCT Filed: Nov. 29, 2022
(86) PCT No.: PCT/NL2022/050688

§ 371 Date: May 28, 2024

(30) Foreign Application Priority Data
Nov. 29, 2021 (EP) 21211144.7

(51) Int. Cl. A23J 3/14; A23J 3/22; A23J 3/26; A23L 13/40

(52) U.S. Cl. CPC A23J 3/14; A23J 3/227; A23J 3/26; A23L 13/426

(57) ABSTRACT

The invention provides a low-moisture extruded texturized vegetable protein, defined as a fibrous and firm protein material obtained by extrusion at a moisture content of 20-30 wt. %, said texturized vegetable protein having a protein content of at least 70 wt. % relative to dry matter, which texturized vegetable protein is prepared by extrusion of a feed composition comprising
a) a source of plant protein from seed, cereal, algae, fruit, leaf or legume comprising at least 65 wt. % plant protein, relative to dry matter; and
b) a source of tuber protein, comprising at least 75 wt. % tuber protein, relative to dry matter.

The invention furthermore provides food products comprising the TVP of the invention, as well as methods for obtaining these products, and use thereof for substituting animal-derived meat in food products.

### BACKGROUND

The technique of extrusion cooking of protein is an upcoming technique in the art of industrial food preparation, which is being developed to ever more sophisticated levels. Extrusion cooking is performed in an extruder. An extruder comprises one or more rotating screws (e.g. single or twin screw, co-rotating or counter-rotating), located in consecutive blocks, which blocks collectively form the barrel. Each block can be heated or cooled independently, as desired. A proteinaceous material fed to the extruder can get plasticized under the influence of high heat and shear conditions inside the barrel, which is generally done in the presence of additional water and/or further ingredients.

The plasticized mass which is formed in the extruder moves through is the barrel by the rotation of the screws to an outlet orifice located in the last block, called the die, which provides a counter force to the mass flow resulting in a pressure build-up in the barrel. Upon exiting the die, the pressure is released and the plasticized mass quickly equilibrates with room conditions. During this process, the protein and other ingredients undergo a variety of physicochemical modifications, thereby altering the properties of the protein.

By extrusion cooking, protein material can be provided with enhanced functional, physicochemical and sensory properties. For example, a protein powder may be transformed by extrusion cooking into a protein product of very different size, shape, hardness or elasticity, than the initial product. For example, “fluffy” (foam-like) aerated protein products may be obtained, as well as elastic, crumbly, soft, firm, rubbery or fibrous materials. What type of product is obtained depends to a large extent on the different ingredients which are present during extrusion, as well as on the applied conditions. It is not at present understood why a specific feed composition provides for particular characteristics of the resulting product, under given conditions.

The presence of fibrous protein is an important characteristic of meat products. The presence of fibrous protein is therefore also a desirable attribute when making vegetarian and vegan meat analogues. To this end, non-meat protein, such as plant protein, can be converted into texturized vegetable protein (TVP).

TVP has been defined as a fabricated palatable food ingredient processed from an edible protein source, optionally with other ingredients, for nutritional or technological purposes. Protein sources often used for such applications include soy protein, pea protein or wheat protein. Although TVP can have many physical characteristics, one particularly desired characteristic is fibrosity.

Extrusion cooking to obtain TVP is conventionally classified into two general methods: high moisture extrusion (HME) and low moisture extrusion (LME). High moisture conditions (40-80% moisture inside the barrel) are known to provide for good fibrosity (see e.g. Samard, J. Sci. Food. Agric. 2019, 99, 4922-4931), because due to the high moisture content, the extrusion process allows for obtaining a layered structure which transforms to a product with high fibrosity upon exiting the die.

HME however has the drawback that due to the high moisture content, the solids output of an HME process is low. In addition, the resulting product has high moisture content, for which reason it has a limited shelf-life; it must be used immediately to obtain a usable food product. Alternatively, it may be further processed (e.g. freezing) to allow for storage, which can have a strong influence on the properties of the HME product. Even then, the high moisture content of such products renders transport of the product over longer distances uneconomical.

Protein products obtained from extrusion cooking under low moisture conditions (generally less than 35% moisture) do not suffer from these drawbacks. The obtained product is more or less dry, has high solids content, and is stable for many months even under ambient conditions. An LME product can thus be stored and transported without difficulties.

However, extrusion under low moisture conditions generally does not lead to fibrous products. Instead, products extruded under low moisture conditions are mostly amorphous, glassy or spongy.

Some attempts have been made to produce fibrous (texturized) protein products under low moisture conditions. The desired fibrous structure can however only be obtained by co-extrusion with additional ingredients. Addition of fiber or carbohydrates, among which starch, is well-known for this purpose. Such additional ingredients however have the drawback that they lower the protein content of the product. In addition, a high carbohydrate content is perceived as unnatural in meat substitute products. Wheat gluten are also used in order to impart fibrosity in an LME process, but due to allergenic concerns, addition of wheat gluten is generally considered unfavorable.

There thus remains a need to provide for a texturized vegetable protein material of high fibrosity, which can be obtained with high protein content using an LME process, which is widely applicable in the food industry. The present invention provides for such a material.

### SUMMARY

The invention is based on the insight that low moisture extrusion of mixtures of tuber protein and plant protein from seed, cereal, algae, fruit, leaf or legume provides for fibrous TVP products, even when pure tuber protein or pure plant protein from seed, cereal, algae, fruit, leaf or legume, extruded under the same conditions, do not provide for fibrous TVP products.

The invention thus provides a fibrous TVP product prepared by low moisture extrusion, having a protein content of at least 70 wt. % relative to dry matter, prepared from a feed composition comprising
a) a source of plant protein from seed, cereal, algae, fruit, leaf or legume comprising at least 65 wt. % plant protein, relative to dry matter; and
b) a source of tuber protein, comprising at least 75 wt. % tuber protein, relative to dry matter.

It has been found that the TVP product of the invention has high fibrosity and high firmness, at a higher protein content than presently achievable. This TVP product has beneficial properties when used in food products such as for example vegetarian and vegan meat substitutes.

The invention furthermore provides food products comprising the TVP product of the invention, as well as methods to prepare the TVP product and the food product, and use of the TVP product for substituting animal-derived meat.

### FIGURES

FIG. 1: fibrosity scoring scale, used to assess fibrosity.

### DETAILED DESCRIPTION

Surprisingly, it has been found that above mentioned issues to obtain a texturized vegetable protein (TVP) under LME conditions can be solved by co-extrusion of plant protein from seed, cereal, algae, fruit, leaf or legume with tuber protein. The substitution of plant fibres or carbohydrates used in the prior art to impart fibrosity, by tuber protein results in a favorable increase in the protein content of the TVP product, and also imparts fibrosity. The low moisture extruded TVP of the invention thus has excellent fibrous structure, as well as high firmness. This is surprising, because under identical extrusion conditions, neither plant protein from seed, cereal, algae, fruit, leaf or legume nor tuber protein provides a fibrous material. Only when mixed, a fibrous and firm product can be obtained.

The invention thus provides a low-moisture extruded texturized vegetable protein having a protein content of at least 70 wt. % relative to dry matter, which texturized vegetable protein is prepared by extrusion of a feed composition comprising
a) a source of plant protein from seed, cereal, algae, fruit, leaf or legume comprising at least 65 wt. % plant protein, relative to dry matter; and
b) a source of tuber protein, comprising at least 75 wt. % tuber protein, relative to dry matter.

In the present context, a low-moisture extruded texturized vegetable protein is defined as a fibrous vegetable protein material which is obtained by extrusion under low moisture conditions. The material is called a texturized vegetable protein, in line with the conventional name for texturized protein, although a TVP of the invention may comprise protein derived from sources not always considered “vegetable”. The word vegetable, in the abbreviation TVP, is to be interpreted as “plant-derived”.

Low moisture conditions, in this context, refers to a moisture content of 18-34 wt. %, preferably 20-30 wt. %, more preferably 21-29 wt. %, even more preferably 22-28 wt. %, most preferably 23-27 wt. %. Thus, the low-moisture extruded texturized vegetable protein of the invention may also be referred to as a texturized protein obtainable by extrusion under conditions comprising a moisture content of 18-34 wt. %, preferably 20-30 wt. %, more preferably 21-29 wt. %, even more preferably 22-28 wt. %, most preferably 23-27 wt. %. An alternative preferred moisture content is 18-28 wt. %, or 19-26 wt. %.

Low moisture conditions as defined herein have the advantage that the fibrous protein material obtained has a high solids content, and does not require further processing in order to attain a long shelf life. The shelf life of the obtained product without further processing is at least 3 months, preferably at least 6 months.

The texturized vegetable protein of the invention has the further advantage that it has a high protein content, relative to dry matter. The protein content is at least 70 wt. %, preferably at least 75 wt. %, more preferably at least 80 wt. %, relative to dry matter. The high protein content of the present TVP is an advantage relative to TVP products with lower protein contents, because high protein content is a much sought characteristic in many food products, in particular extended meat products and vegetarian or vegan meat substitutes.

The texturized vegetable protein of the invention has the further unexpected advantage that it possesses high fibrosity and high firmness.

High fibrosity is an advantage for TVP products which are to be used as meat replacement proteins in various food products, because fibrosity is a characteristic of meat proteins. The high fibrosity of the present product distinguishes it from prior art products, in particular low moisture extruded products.

High firmness, also, is an important characteristic for a TVP product, because the firmness dictates chewability. High firmness provides for a strong bite resembling the bite of animal meat, whereas lower firmness is generally perceived as more elastic, leading to a soft product.

The texturized vegetable protein of the invention is prepared by low moisture extrusion of a feed composition comprising a source of plant protein from seed, cereal, algae, fruit, leaf or legume comprising at least 65 wt. % plant protein, relative to dry matter, and a source of tuber protein, comprising at least 75 wt. % tuber protein, relative to dry matter.

The feed composition refers to a mixture which is fed into the extruder. Preferably, the feed composition is a homogenous powder mixture, comprising said source of plant protein from seed, cereal, algae, fruit, leaf or legume and said source of tuber protein. The feed composition can be used as a dry mix having a moisture content 1-15 wt. %. Preferably, the feed composition is used under standard factory conditions, such as at a moisture content of 5-15 wt. %, preferably 5-12 wt. %.

The source of plant protein from seed, cereal, algae, fruit, leaf or legume is preferably provided as a powder. A source of plant protein can be referred to as a concentrate or an isolate, depending on the protein concentration of the powder. A protein concentrate is generally understood to mean a protein source comprising more than 55 wt. % protein and less than 80% wt. % protein, relative to dry matter. A protein isolate is generally understood to mean a protein source comprising at least 80 wt. % protein, relative to dry matter.

The source of plant protein from seed, cereal, algae, fruit, leaf or legume comprises at least 65 wt. %, preferably at least 66 wt. %, more preferably at least 67 wt. %, more preferably at least 68 wt. %, more preferably at least 69 wt. %, more preferably at least 70 wt. %, more preferably at least 71 wt. %, more preferably at least 72 wt. %, more preferably at least 73 wt. %, more preferably at least 74 wt. %, more preferably at least 75 wt. %, more preferably at least 76 wt. %, more preferably at least 77 wt. %, more preferably at least 78 wt. %, more preferably at least 79 wt. %, more preferably at least 80 wt. % of plant protein, relative to dry matter. The source of plant protein can be a plant protein concentrate (generally having a protein content of up to 80 wt. %), or as plant protein isolate (generally having a protein content of at least 80 wt. %). The source of plant protein is preferably a free flowing powder.

The source of plant protein from seed, cereal, algae, fruit, leaf or legume is generally commercially available, or can be obtained by methods well known to those skilled in the art. Seed protein is preferably obtained from protein rich seed, such as seed used for isolation of plant oil. Preferred examples of seed protein include canola protein, rapeseed protein, flax protein, and hemp protein. Typical examples of cereal protein include protein obtained from wheat, rye, barley, oat, rice, sorghum, millet or corn. Algae protein can be protein derived from algae, among which macroalgae (“seaweed”) and microalgae (unicellular algae, such as chlorella or spirulina). Fruit protein can be derived from any type of fruit, such as orange, lemon, apple, pear or banana. Preferred examples of leaf protein are rubisco protein and lemna protein. Preferred examples of legume protein are protein from soybean, faba bean, mung bean, haricot, kidney bean, black bean, horse bean, Lima bean pea, cow pea, green pea, yellow pea and chickpea, as well as from peanut, lentil or lupin.

In much preferred embodiments, the source of plant protein provides a legume protein. The legume protein can be a protein from any type of legume. The skilled person is well aware what type of protein is legume protein; legume protein is protein derived from a plant from the family of Leguminosae, preferably from a seed from such a plant. Legume protein may thus be derived from legume such as a pulse, among which a bean such as soybean, faba bean, mung bean, haricot, kidney bean, black bean, horse bean or Lima bean, a type of pea such as (regular) pea (Pisum sativum), cow pea, green pea, yellow pea and chickpea, as well as from peanut, lentil or lupin. In preferred embodiments, the legume protein is a pulse protein.

In order to obtain a non-allergenic product, soy protein is preferably not used as a legume protein. A non-allergenic TVP of the invention prepared from a source of legume protein thus comprises, as legume protein, any pulse protein excluding soy. In preferred embodiments, the source of legume protein comprises a protein from pea, chickpea, faba bean, kidney bean, black bean, mung bean, cow pea, horse bean, Lima bean, green pea, yellow pea or haricot. In further preferred embodiments, the source of legume protein is a source of protein from faba bean, pea, chickpea, peanut, lentil or lupin, preferably of pea, chickpea or faba bean, most preferably of (regular) pea (Pisum sativum).

In another preferred embodiment the source of legume protein comprises a protein isolated from soy bean, faba bean, pea, or chickpea, preferably from soy bean or pea.

In another preferred embodiment, a non-allergenic TVP of the invention does not comprise wheat gluten. In a much preferred embodiment, a TVP of the invention is free of gluten and soy.

The source of plant protein from seed, cereal, algae, fruit, leaf or legume can be a native protein, or a coagulated protein. In preferred embodiments, the plant protein is non-functional. In further preferred embodiments, the plant protein is a coagulated protein. The source of plant protein from seed, cereal, algae, fruit, leaf or legume can be an isolate or a concentrate, such as conventionally obtained by either dry milling and air classification or wet milling after de-hulling (Handbook of Food Proteins, G. O. Phillips and P. A. Williams, Eds. Woodhead Publishing Limited, 2011, chapter 9).

Dry milling followed by air classification selecting the fine, protein rich fraction generally provides a protein concentrate with up to 75 wt. % protein, mainly depending on the type of plant.

During wet milling (or “wet fractionation”), protein is extracted under alkaline or acidic conditions from a plant flour (defined as a source of plant protein comprising less than 55 wt. % of protein), followed by centrifugation or similar technology to separate solubilized protein from the residue. Proteins are recovered by isoelectric precipitation or ultrafiltration, thereby providing a plant protein isolate with up to 95 wt. % protein content on dry weight. The skilled person in the food industry is well aware of sources of plant protein, as such isolates or concentrates are commercially available.

The source of tuber protein comprises at least 75 wt. %, preferably at least 76 wt. %, more preferably at least 77 wt. %, more preferably at least 78 wt. %, more preferably at least 79 wt. %, more preferably at least 80 wt. %, more preferably at least 81 wt. % of tuber protein, relative to dry matter. The source of tuber protein can be referred to as a tuber protein concentrate (generally having a tuber protein content of up to 80 wt. %), or as tuber protein isolate (generally having a tuber protein content of at least 80 wt. %); the source of tuber protein is preferably a free flowing powder.

The source of tuber protein can provide a protein derived from any type of tuber. The term tuber, in the present context, is to be given its regular meaning, and refers to any type of tuber. In particular, tuber in the present definition includes structures which may also be called root. The term “tuber” as herein defined may thus be replaced with the phrase “root or tuber”.

Preferably, a tuber in the present context is an edible tuber, which may be grown in the context of human food production. Tuber inherently comprises protein; preferred types of tuber are also rich in starch, such as tuber used for starch isolation. Tuber protein is understood to mean a protein from one type of tuber, or a particular protein fraction from one type of tuber, although in special cases, tuber protein may comprise a mixture of protein derived from two or more types of tuber.

Preferably, tuber in this context comprises potato (Solanum tuberosum), sweet potato (Ipomoea batatas), cassava (including Manihot esculenta, syn. M. utilissima, also called manioc, mandioca or yucca, and also including M. palmata, syn. M. dulcis, also called yucca dulce), yam (Dioscorea spp), and/or taro (Colocasia esculenta). More preferably, the tuber comprises potato, sweet potato, cassava or yam, even more preferably the tuber comprises potato, sweet potato or cassava, even more preferably the tuber comprises a potato or sweet potato, and most preferably the tuber comprises potato (Solanum tuberosum).

Preferred tuber protein comprises potato protein, sweet potato protein, cassava protein, yam protein, and/or taro protein. Most preferably said tuber protein isolate is a tuber protease inhibitor isolate, a tuber patatin isolate, or a tuber isolate comprising a mixture of protease inhibitor and patatin. A tuber protein isolate in the present context may be a native tuber protein isolate, or a denatured tuber protein isolate, such as obtainable by coagulation of tuber protein.

Preferably, the source of tuber protein is a native potato protein, such as obtainable following the methods in WO 2014/011042, or a coagulated potato protein, such as obtainable by following the methods in WO 2017/142406 or in WO 2016/133448. Potato protein is a preferred type of tuber protein, because potato protein is known as an excellent source for essential amino acids, having an average DIAAS above 100. Potato protein thus possesses an essential amino acid score close to that of animal protein (Herreman et al. Food Science & Nutrition, 2020, 00:1-13, Comprehensive overview of the quality of plant- and animal sourced proteins based on the digestible indispensable amino acid score). Potato protein can thus be used to complement the amino acid profile of protein from seed, cereal, algae, fruit, leaf or legume, which have a lower amino acid score.

Most preferably, the source of tuber protein is a coagulated potato protein. Both native tuber protein and coagulated tuber protein, including native potato protein and coagulated potato protein, is commercially available.

In preferred embodiments, the quantity of tuber protein in the feed composition is 2.5-95 wt. %, preferably 5-90 wt. %, more preferably 7.5-75 wt. %, more preferably 10-50 wt. %, relative to total protein. In further preferred embodiments, the quantity of tuber protein in the feed composition is 2.5-50 wt. %, preferably 2.5-40 wt. %, more preferably 5-30 wt. %, even more preferably 7.5-25 wt. %, relative to total protein.

The quantity of plant protein from seed, cereal, algae, fruit, leaf or legume in the feed composition is preferably at least 50 wt. %, more preferably at least 60 wt. %, more preferably at least 70 wt. %, most preferably at least 75 wt. %, relative to total protein. That is, in much preferred embodiments, the quantity of plant protein from seed, cereal, algae, fruit, leaf or legume exceeds the quantity of tuber protein, on a total weight basis (including moisture of the raw materials). The ratio of plant protein from seed, cereal, algae, fruit, leaf or legume to tuber protein in the feed composition is preferably 19:1-1:1, more preferably 19:1-3:1.

In much preferred embodiments, the feed composition comprises a quantity of protein from seed, cereal, algae, fruit, leaf or legume of at least 50 wt. %, preferably at least 60 wt. %, relative to dry matter. The quantity of tuber protein in the feed composition is preferably 2.5-50 wt. %, more preferably 5-30 wt. %, relative to dry matter.

It is a distinct advantage of the present invention that the protein content in the feed composition, and therefore also in the obtained TVP product, is high. Due to the presence of the tuber protein, the addition of plant fiber or of carbohydrates, among which starch, is no longer required to obtain a fibrous product.

Thus, the feed composition preferably comprises less than 10 wt. %, preferably less than 5.0 wt. %, more preferably less than 2.5 wt. %, even more preferably less than 0.5 wt. % of plant fiber, relative to dry matter. Plant fiber, in this context, refers to non-proteinaceous fibrous materials derived from plants.

Plant fiber, in the present context, refers to a material which is commercially available, generally in the form of a free flowing powder, and which may be added to the feed composition. Many types of plant fiber are generally known in the art. Examples include soy cotyledon fiber, pea fiber, potato fiber, and grain fiber, among which wheat fiber, barley fiber or oat fiber. Plant fiber is thus to be distinguished from crude fiber, which refers to the fibrous portion of a plant material which may be inherently present in a source of protein.

Plant fibers, as referred to herein, generally include various types of indigestible carbohydrates among which pectins, hemi-cellulose, and/or gums, but furthermore comprises non-soluble cell wall components remaining after acid and alkaline hydrolysis.

Further, the feed composition preferably comprises less than 10 wt. %, preferably less than 5.0 wt. %, more preferably less than 2.5 wt. %, even more preferably less than 0.5 wt. % of crude fiber, relative to dry matter. Crude fiber, in this context, refers to the non-soluble cell wall components remaining after acid and alkaline hydrolysis, such as cell wall fragments present in many sources of plant protein from seed, cereal, algae, fruit, leaf or legume, as well as in some sources of tuber protein.

In further preferred embodiments, the feed composition comprises less than 15 wt. %, preferably 10 wt. %, more preferably less than 5.0 wt. % of carbohydrates, relative to dry matter. Carbohydrates in this context refers to the total weight of fructose, galactose and glucose after acid hydrolysis.

In preferred embodiments, the feed composition comprises less 15 wt. %, preferably less than 10 wt. %, more preferably less than 5.0 wt. % of carbohydrates. In particular the feed composition comprises less than 15 wt. %, preferably less than 10 wt. %, more preferably less than 5.0 wt. % of starch, relative to dry matter.

Furthermore, the feed composition preferably comprises less than 15 wt. %, preferably less than 12 wt. %, preferably less than 10 wt. % of lipid. In addition the feed composition preferably comprises at least 1 wt. %, more preferably at least 2 wt. %, more preferably at least 3 wt. %, more preferably at least 4 wt. %, more preferably at least 5 wt. % lipid. A lipid, in this context, is an oil or fat which is naturally present in the raw materials, or which may be added separately to the feed composition.

A lipid in the present context includes for example free fatty acids, mono-, di, or triglycerides, sucrose fatty acid esters and sorbitan fatty acid esters. The quantity of lipid is defined as the total weight of the fatty acids present in the feed composition.

In much preferred embodiments, the feed composition comprises no separately added lipids, so that no additional fat or oil is added to the feed composition prior to the extrusion.

In further preferred embodiments, the source of plant protein from seed, cereal, algae, fruit, leaf or legume applied in the feed composition comprise less than 12 wt. %, preferably less than 10 wt. %, of lipid. In some embodiments, the source of plant protein from seed, cereal, algae, fruit, leaf or legume comprises at least some lipid. In preferred embodiments, the lipid content of the source of plant protein from seed, cereal, algae, fruit, leaf or legume is 3-10 wt. %, preferably 4-9 wt. %.

A source of tuber protein for use in the feed composition preferably comprises less than 6 wt. %, more preferably less than 5 wt. %, more preferably less than 4 wt. %, more preferably less than 3 wt. %, more preferably less than 2 wt. %, more preferably less than 1 wt. % of lipid. In some embodiments, the source of tuber protein comprises at least some lipid. In some preferred embodiments, the lipid content in the source of tuber protein is 0.1-5 wt. % lipid.

The feed composition as defined is processed by low moisture extrusion, as defined above. The low moisture extrusion setup to obtain the TVP of the invention preferably comprises an extruder comprising a barrel section comprising at least 3 blocks, preferably at least 5 blocks, the first block of the barrel section comprising a feed inlet adapted for feeding the feed composition into the extruder, the second block, located downstream of the first block of the barrel section, comprising a water inlet adapted for introducing water into the extruder, and one or more further downstream blocks adapted to setting the temperature along the barrel section to comprise an increasing temperature gradient, said extruder further comprising a die section located downstream of the barrel section, and one or more screw elements adapted to convey the feed composition through the barrel section to the die section.

The first block in the barrel section comprises a feed inlet, adapted for feeding a feed composition as herein defined into the extruder. The second block in the barrel section, located downstream of the first block, comprises a water inlet, adapted for introducing water into the extruder so as to attain the desired moisture content of between 18 and 34 wt. %, preferably between 20 and 30 wt. % (based on the total weight of the composition). The first and the second block are preferably operated under more or less ambient conditions (20-30° C.). One or more further downstream blocks in the barrel section are preferably equipped with means for heating and cooling, so as to allow for setting the temperature along the barrel section to comprise an increasing temperature gradient. In preferred embodiments, the temperature increases step wise to a maximum temperature of 100-250° C., more preferably 130-180° C., even more preferably 140-160° C.

Although the barrel section must comprise an increasing temperature gradient, it is conceivable that in some setups, the barrel section may comprise one or more barrel parts in which there is a decreasing temperature gradient, or a constant temperature. Such barrel parts may be combined with for example one, two or more barrel parts with an increasing temperature gradient, as the skilled person appreciates.

The barrel section furthermore comprises a die section located downstream of the barrel section, and one or more screw elements adapted to convey the feed composition through the barrel section to the die section. In preferred embodiments, the barrel section is equipped with a co-rotating twin screw. Further preferably, the screw configuration comprises reversed pitch elements and conveying elements, preferably alternatingly. In further preferred embodiments, the screw configuration comprises 2-10 reversed pitch elements. Reversed pitch elements are preferably located of from 10 D to 20 D. In much preferred embodiments, a reversed pitch element, preferably the reversed pitch element furthest downstream, is followed downstream by a kneading block, preferably having a stagger angle of between 35 and 55°, most preferably between 4° and 50°. In further preferred embodiments, the die section comprises a die having one, or two or multiple outlets, preferably one or two outlets, through which outlet(s) the extruded feed mass exits the extruder.

Extrusion conditions for obtaining the TVP of the invention preferably comprise a temperature in the barrel section of 100-250° C., more preferably 130-180° C., even more preferably 140-160° C. This value refers to the maximum temperature observed in a temperature gradient. Alternatively or additionally, the conditions comprise a pressure at the die, i.e. after the screw before the die of 2-50 bar, preferably 10-30 bar; and/or a specific mechanical energy (SME) of 0.05-0.35 kWh/kg, preferably 0.10-0.28 kWh/kg, preferably 0.14-0.25 kWh/kg. The extruder can be operated at 100-1800 screw rotations per minute (rpm), preferably 200-1250 rpm, more preferably 250-750 rpm; alternatively, the extruder can preferably be operated at 250-1600 rpm. Higher rotation speeds, such as 500-1600 rpm, preferably 900-1500 rpm, provide for higher throughput and hence improved production efficiency.

In an exemplary embodiment, the extruder can be a ZSK 27 extruder (a co-rotating twin-screw extruder marketed by Coperion). In this particular embodiment, further described in the examples, the extruder comprises 6 blocks, having a total length of 24 D. The diameter D of the screws is 27 mm. The barrel section, and thus the screws, have a total length of 648 mm, and the screw diameter is 27 mm.

In this exemplary embodiment, the screw configuration comprises seven reversed pitch elements alternatingly intertwined with conveying elements. The reversed pitch elements are preferably placed towards the end of the screw starting at position 14 D. The furthest downstream reversed pitch element is preferably followed downstream by a kneading block (about 45° stagger angle) at position 21.5 D and by a conveying element right before the screw tip at position 23D. The die section comprises two conical cavities, comprising cylindrically shaped die holes having a diameter of 3 mm and a length of 2 mm.

In this particular embodiment, the temperature in the first (feeding) block and second (water addition) block can be more or less ambient. The third and fourth blocks are operated at a temperature of 50-100° C., preferably 60-90° C. The fifth and sixth blocks are operated at a temperature of 100-250° C., preferably 130-180° C., more preferably 140-160° C. The throughput is 15 to 25 kg/h based on total weight (including moisture) and operated at 500 rpm. At higher rotation speed, the throughput can be higher, as the skilled person appreciates. The throughput can be 10-100 kg/h, preferably 15-80 kg/h. At 800-1600 rpm, the throughput can be 40-80 kg/h.

In this particular embodiment, the pressure at the die is 1.5-80 bar, preferably 2-50 bar, more preferably 10-30 bar, and the extruder is operated at a specific mechanical energy (SME) of 0.05-0.35 kWh/kg, preferably 0.10-0.28 kWh/kg, more preferably 0.14-0.25 kWh/kg.

Using the described feed composition and the low moisture extrusion process described above, the TVP of the invention having high fibrosity and firmness can generally be obtained. The texturized vegetable protein has a moisture content of 1-20 wt. %, preferably 5-15 wt. %, more preferably 5-12 wt. %, and comprises, as wt. % relative to dry matter,
a) at least 70 wt. %, preferably at least 75 wt. %, more preferably at least 80 wt. %, of protein; and/or
b) less than 15 wt. %, preferably less than 12 wt. %, more preferably less than 10 wt. % lipid; and/or
c) at least 1 wt. %, preferably at least 2 wt. %, more preferably at least 3 wt. %, more preferably at least 4 wt. %, more preferably at least 5 wt. % lipid; and/or
d) less than 10 wt. %, preferably less than 5.0 wt. %, more preferably less than 2.5 wt. %, even more preferably less than 0.5 wt. % of plant fiber; and/or
e) less than 10 wt. %, preferably less than 5.0 wt. %, more preferably less than 2.5 wt. %, even more preferably less than 0.5 wt. % of crude fiber; and/or
f) less than 15 wt. %, preferably 10 wt. %, more preferably less than 5.0 wt. % of carbohydrates, relative to dry matter; and/or
g) less than 150 ppm, preferably less than 100 ppm, more preferably less than 80 ppm, more preferably less than 50 ppm, more preferably less than 30 ppm of total triglycoalkaloids (TGA).

In much preferred embodiments, the TVP of the invention comprises all features a)-g) in combination. The skilled person is capable of adjusting the feed composition so as to obtain a preferred TVP of the invention.

The TVP of the invention may be further dried to moisture contents of less than 10 wt. %, preferably less than 8 wt. %, more preferably less than 7 wt. % in order to enhance the microbiological stability and/or the shelf life. Additional drying can be achieved by any means known in the art.

A TVP of the invention preferably has a high moisture adsorption. Moisture adsorption can be expressed using the water adsorption index (WAI); the WAI expresses how much water can be adsorbed by dry TVP as a weight equivalent (expressed as %). A TVP of the invention preferably has a WAI of 100-1000, more preferably 250-750, even more preferably 300-650.

In further preferred embodiments, a TVP of the invention may be provided with additional texturization, flavoring or coloring, in order to mimic real meat fibers even further. To achieve this, suitable flavors, colorants and/or texturizers can be mixed into the feed composition, or be provided with the added water. Suitable texturizers, flavors and colorants include salts, such as sodium or potassium chloride, as well as alkali metal and alkali earth metal salts of hydroxide, carbonate, bicarbonate, phosphate and monohydrogen phosphate. Preferred alkali metal and alkali earth metal hydroxides are sodium, calcium, magnesium and/or potassium hydroxide. Salts furthermore comprise various organic acid salts such as citrate and lactate salts. The group of suitable texturizers, flavors and colorants furthermore includes various food-grade organic acids such as citric acid and lactic acid, as well as sugars, in particular reducing sugars so as to impart Maillard browning to the TVP product.

Furthermore, lipid compounds may be added such as free fatty acids, mono-, di, or triglycerides, sucrose fatty acid esters and sorbitan fatty acid esters, including polyoxyethylene sorbitan fatty acid esters.

The quantity of protein in a TVP composition of the invention can be determined by Kjeldahl analysis using a correction factor of 6.25, as is generally known in the art (EC regulation Nr. 152/2009, Annex III, Method C, Dairy, equal to NEN-EN-ISO 8968-1).

The quantity of triglycoalkaloids can be measured by AOAC Official method 997.13.

The quantity of lipid can be determined by a method comprising acid hydrolysis and subsequent gravimetric determination of the total weight of the fatty acids. Fatty acids, in this context, are all C2-C26 fatty acids.

The quantity of crude fiber, i.e. the non-soluble cell wall components remaining after acid and alkaline hydrolysis can be determined conform to AOAC 991.43 based on EC regulation Nr. 152/2009, Annex III, Method I.

The quantity of carbohydrates is determined by submitting the sample to an acid hydrolysis step that converts polysaccharides including non-starch polysaccharides into free sugars and determining the total weight of fructose, galactose and glucose by HPLC using a pulsed amperometric detector (PAD). Total carbohydrates expresses the sum of free and polymerized fructose, galactose and glucose present. Free sugars are determined by HPLC analysis from an aqueous extract without acid hydrolysis, and provides the quantities of fructose, galactose, glucose, maltose, lactose and saccharose present in the sample.

A TVP of the invention is characterized by a high fibrosity and a high firmness, as compared to other low moisture extruded TVP products.

The fibrosity of a TVP of the invention is determined visually, using the method set forth in the examples. Fibrosity is high when the fibrosity value is 2 or more, preferably 3 or more, more preferably 4 or more, on a 5 point scale. Fibrosity of a TVP prepared from a particular feed composition can be increased, when occasionally needed, by performing the extrusion at a lower moisture content.

The firmness of a TVP of the invention is determined using a texture analyzer, for example using the Warner Bratzler method, as set forth in the examples. Firmness can be expressed as absolute firmness (in Newton, “N”), or relative to the sample thickness (in Newton per mm, “N/mm”). Sample thickness of a TVP of the invention is generally 5-25 mm, preferably 6-15 mm, preferably 7-12 mm. Sample thickness is the diameter of the sample perpendicular to the fibre direction (i.e. perpendicular to machine direction) as obtained after extrusion and equilibrated to ambient conditions after full hydration.

Absolute firmness measured in Newton depends on the sample thickness. Absolute firmness of a TVP of the invention produced according to the invention is generally 5-30 N, preferably 8-25 N, such as for example 8-15 N, preferably 9-14 N, or 12-30 N, preferably 15-25 N. Relative firmness takes into account the variation in sample thickness, and is expressed in N/mm. Relative firmness is generally 1.0-3.0, such as for example 1.0-1.8 N/mm, or 1.5-2.3 N/mm. Firmness is considered high when relative firmness is more than 1.0 N/mm, preferably more than 1.1 N/mm, more preferably more than 1.2 N/mm. Absolute and relative firmness of a TVP prepared from a particular feed composition can be increased, when occasionally needed, by performing the extrusion at a higher moisture content.

The TVP characteristics, including fibrosity and firmness, are determined by the feed composition, as well as by the conditions of the extrusion. The skilled person is capable of balancing fibrosity and firmness of a TVP from a particular feed composition based on the above guidance, in order to obtain a TVP of the invention satisfying intended features.

The invention furthermore discloses a method for preparing a low-moisture extruded texturized vegetable protein comprising
a) providing a feed composition as defined above, said feed composition having a moisture content of 1-15 wt. %, preferably 5-12 wt. %, relative to the total weight of the feed composition;
b) introducing the feed composition into an extruder comprising a barrel section comprising at least 3 blocks, preferably at least 5 blocks, the first block of the barrel section comprising a feed inlet adapted for feeding the feed composition into the extruder, the second block, located downstream of the first block of the barrel section, comprising a water inlet adapted for introducing water into the extruder, and one or more further downstream blocks adapted to setting the temperature along the barrel section to comprise an increasing temperature gradient, said extruder further comprising a die section located downstream of the barrel section, and one or more screw elements adapted to convey the feed composition through the barrel section to the die section;
c) extruding the feed composition at a moisture content of 18-34 wt. %, preferably 20-30 wt. %, more preferably 22-28 wt. %, relative to the total weight of feed composition, under extrusion conditions comprising
a temperature in the barrel section of 100-250° C., preferably 130-180° C.; and/or
a die pressure of 1.5-80 bar, preferably 2-50 bar, more preferably 10-40 bar, such as for example 10-30 bar or 20-40 bar; and/or
a specific mechanical energy (SME) of 0.05-0.35 kWh/kg, preferably 0.10-0.28 kWh/kg, more preferably 0.14-0.25 kWh/kg; and/or
50-1800 screw rotations per minute (rpm), preferably 250-1600 rpm, such as 100-1250 rpm, more preferably 250-750 rpm, or 800-1600 rpm.

Extruding, in this context, means that the feed composition is moved through the barrel by the rotating screws toward the die section, and subsequently exits the extruder through the outlet(s) in the die section. The extruded feed composition preferably exits the extruder through the outlet(s) in the die section in the form of an expanded strand. In much preferred embodiments, the expanded strand is subsequently comminuted, for example using a pelletizer (a rotating cutting device), as is known in the art. The expanded strand is preferably comminuted to portions having a length of 0.5-7 cm, preferably 2-5 cm, in machine direction.

In further preferred embodiments, the method furthermore comprises a step of drying the expanded strand, or the comminuted portions, to a moisture content of less than 10 wt. %, preferably less than 8 wt. %, more preferably less than 7 wt. %. This further enhances the microbiological stability and/or the shelf life of the TVP product. Said drying can be achieved by any means known in the art.

All features of the method of the invention have been described above with reference to the TVP of the invention. Any description of a feature described in the context of the TVP of the invention also is applicable to the method of the invention.

### Uses of TVP

A TVP of the invention is particularly suitable for use in food products, preferably human food products. The invention thus also provides a food product comprising a low-moisture extruded texturized vegetable protein as defined above. The high protein content renders a TVP of the invention particularly nutritious, which results in food products of the invention also being particularly nutritious. In addition, the high fibrosity and high firmness of a TVP of the invention impart a food product of the invention with a palatable structure, without suffering the drawbacks of high moisture extruded products. This increases processability and usability of a TVP of the invention in the food industry. Prior to its use in a food product, the TVP strand, or preferably the comminuted smaller portions thereof, obtained after extrusion, is preferably further comminuted to smaller size particles, such as particles of from 0.1-20 mm, preferably 0.5-15 mm, more preferably 0.5-10 mm, or even 0.5-5 mm. The particle size can be determined by sieve analysis, which analysis method is well-known in the art.

Preferred food products of the invention are food products which are rich in protein (protein-rich food products), e.g. food products comprising at least 5 wt. % of protein, more preferably at least 7.5 wt. %, even more preferably at least 10 wt. %, relative to the total weight of the food product. Alternatively, protein-rich food products are food products in which protein is present in a quantity to contribute to the nutritional value of the food product for at least 20 en. %, preferably at least 25 en. %, more preferably at least 30 en. %.

In much preferred embodiments, a food product of the invention is a food product which at least in part is based on or resembles meat. A food product of the invention is preferably a food product in which a TVP of the invention is used as a substitute for animal derived meat. Animal-derived meat, in this context, pertains to any type of meat, including mammalian meat such as beef, pork, sheep or goat, preferably beef, and also including poultry such as chicken and turkey, as well as fish and crustaceans. The invention thus also provides use of a TVP of the invention as a substitute for animal-derived meat in food products.

Preferably, a food product of the invention is an extended meat product, a vegetarian or vegan meat substitute, or a vegetarian or vegan meal component.

An extended meat product, in this context, is a food product which comprises animal-derived meat, but in which part of the animal-derived meat has been substituted for a TVP of the invention. Examples of extended food products include a beef burger, sausage or meat ball, which comprises animal-derived meat in a quantity which is lower than for conventional animal-derived beef burgers, sausages or meatballs, and in which part of the animal-derived meat has been substituted for a TVP of the invention. Extended meat products have the advantage of reducing the consumption of animal-derived meat, while retaining animal-derived meat as a taste component.

A vegetarian or vegan meat substitute is a meat substitute in which animal-derived meat is not present. A vegetarian meat substitute allows for the presence of non-meat animal-derived components (e.g. egg or milk, and, depending on individual preferences, in some cases also fish and/or crustaceans), whereas a vegan meat substitute is fully plant-based, and does not comprise animal-derived components.

Preferred vegetarian or vegan meat substitutes or extended meat products are (vegetarian or vegan versions of) a burger, meat ball, skewer, nugget, sausage, minced meat, schnitzel, rib, filet, fish ball, or meat chunk.

A vegetarian or vegan meal component is a part of a meal which traditionally comprises meat, but which has been developed further to encompass a variant which is animal-derived meat free (vegetarian, which sometimes may still comprise fish and/or crustaceans), or animal derived product free (vegan), implying absence of both animal derived meat as well as other animal-derived products (among which egg, gelatin, milk and the like). Examples include a vegetarian or vegan Bolognese sauce, chili con carne (“chili sin carne”), a pie filling, a taco filling, a burrito filling or a stew. These examples should not be considered limiting, because most food products which traditionally comprise meat can be made using a TVP of the invention as a substitute for animal-derived meat.

The invention further provides a method for making a vegetarian or vegan meat substitute as defined above, comprising
a) hydrating a low-moisture extruded texturized vegetable protein as defined above to obtain hydrated TVP;
b) combining hydrated TVP with one or more ingredients selected from the group of starch, plant fiber, colorants, flavors, fats, oils, emulsifiers, proteins, probiotics, yeast extracts, binders and salts to obtain a raw mix;
c) shaping the raw mix to a desired shape.

In much preferred embodiments, the method for making a vegetarian or vegan meat substitute comprises a step of comminuting the hydrated TVP. Comminution may be done before or after hydration. If comminution is done prior to hydration, comminution is preferably to a particle size of 0.1-20 mm, preferably 0.5-15 mm. If said comminution is performed after hydration, the particle size of the hydrated and comminuted TVP is preferably 0.1-20 mm, more preferably 0.5-15 mm. The step of comminuting preferably results in a particle size of hydrated TVP which is typical for the type of meat substitute that is made. For example, for a burger, the particle size of a TVP of the invention prior to hydration is typically 0.5-5 mm.

The method reflects preparation methods for making a vegetarian or vegan meat substitute as they are generally known in the art, except that in the present method, a TVP of the invention is used. In short: Hydration of the low-moisture extruded texturized vegetable protein can be achieved by any means known in the art. Preferred means of hydration include soaking the TVP in an aqueous solution, which may comprise further ingredients such as salts or sugars, for a period of at least 5 minutes, preferably at least 15 minutes.

Hydration is complete when the TVP of the invention is essentially fully equilibrated with moisture, indicating a moisture content of about 40-80 wt. %. This may take up to 5 hours, but preferably takes up to two hours, more preferably up to one hour.

The second step comprises combining the said hydrated low-moisture extruded TVP with other food ingredients, thereby providing a raw mix. Lipid may be added as a pre-emulsion or may be emulsified in the presence of said hydrated low-moisture extruded TVP. Preparation of said pre-emulsion may comprise mixing lipid, water and a binder and/or an emulsifier; emulsification in the presence of said hydrated low-moisture extruded TVP may comprise preparation of an emulsion comprising said hydrated low-moisture extruded texturized vegetable protein, a lipid, water, an emulsifier, and/or a binder. In preferred embodiments, the raw mix comprises an emulsion comprising said hydrated low-moisture extruded texturized vegetable protein, a lipid, an emulsifier and water.

The lipid can be any lipid, preferably a plant-derived lipid, such as a plant oil, seed oil or fruit oil. In preferred embodiments, the lipid comprises a quantity of triglycerides, relative to the total weight of the lipid, of at least 95 wt. %, preferably at least 98 wt. %. Suitable types of lipid include coconut oil, palm oil, sunflower oil, olive oil, and the like. For vegetarian meat substitutes, butter or cream may also be used.

Water is preferably clean and suitable for human consumption. In preferred embodiments, the water used in the emulsion is mains water.

The binder can be any binder which is suitable for binding a vegetarian or vegan meat substitute. Preferred binders include cellulose binders, alginate binders, gums, starch including native and modified starch, or flour. Alternatively the binder may be a protein binder such as (for vegetarian products) gelatin, or (for vegetarian or vegan products) a heat gelling protein such as a native potato protein, preferably a native patatin isolate.

The emulsion is preferably prepared by high speed mixing of the components. Any order of addition is suitable, as long as it results in a shapeable emulsion. During or after forming the emulsion, optional ingredients such as flavors, colorants, salts, bulking agents and texturizers may optionally be added. The skilled person can decide which optional agents may be suitable for inclusion in which type of vegetarian or vegan meat substitute based on common general knowledge.

The raw mix, preferably the emulsion, is finally shaped into a desired shape. The shape can be any shape, but is preferably a shape which is customary for the type of vegetarian or vegan meat substitute in question. Thus, a burger, for example, may be provided with a “patty” shape, whereas a sausage may be provided with an elongated and optionally bent cylindrical shape.

The invention furthermore provides a method for preparing a food product selected from a vegetarian or vegan meal component, or an extended meat product, comprising following a standard recipe for said food product comprising animal-derived meat, and substituting at least part of the animal-derived meat for a hydrated low-moisture extruded texturized vegetable protein as defined above. A standard recipe, in this context, is a recipe which provides for preparing the food product in question, based on for example a cooking book, as reflective of general knowledge of the person skilled in the art of cooking.

In a preferred embodiment, the invention thus provides a method for preparing a vegetarian or vegan meal component, or an extended meat product, comprising providing a recipe for a food product comprising animal-derived meat, said recipe comprising one or more cooking steps, and executing the cooking steps in the indicated order, wherein the executing of the cooking steps comprises substituting at least part of the animal-derived meat for a hydrated low-moisture extruded texturized vegetable protein as defined above. In embodiments for preparing a vegetarian or vegan meal component, preferably all of the animal-derived meat is substituted for the hydrated low-moisture extruded texturized vegetable protein defined above.

The method for preparing a vegetarian or vegan meal component or an extended meat product preferably comprises one or more of the steps of providing ingredients, mixing ingredients, heating one or more ingredients, individually or as a mixture, cooling one or more ingredients, individually or as a mixture. Furthermore, the method may comprise executing cooking steps such as kneading, aerating, stirring, baking, frying, boiling, simmering, mashing, resting, shaping, stretching, macerating, as well as any further cooking step needed for a particular recipe.

For the purpose of clarity and a concise description features are described herein as part of the same or separate embodiments, however, it will be appreciated that the scope of the invention may include embodiments having combinations of all or some of the features described.

The invention will now be illustrated by the following, non-limiting examples.

### EXPERIMENTAL SECTION

### Raw Materials

tuber protein isolate: coagulated potato protein of Avebe, prepared following the methods described in WO 2017/142406.
legume protein isolate: pea protein isolate obtained from Roquette (trade name Nutralys F85M)
plant fibre: pea fibres obtained from Roquette (trade name L50M).

TABLE 1
Compositional analysis of raw materials expressed on dry solids.

| | | | | Potato protein | Faba bean |
|---|---|---|---|---|---|
| | | Pea protein | Pea fibres | WO | Univar |
| Sample name | on d.s | Nutralys F85M | L50M | 2017/142406 | 90-C-EU |
| Moisture content | (g/kg) | 71 | 87 | 75 | 71 |
| Total protein | (N × 6.25, g/kg) | 824.5 | 78.9 | 823.8 | 934.3 |
| Total fat | (g/kg) | 91.5 | 4.4 | 45.4 | 78.6 |
| Crude fibre | (g/kg) | <1 | 88.7 | — | <1 |
| Total Carbohydrates | (g/kg) | 41.1 | 483.0 | 10.8 | <5.0 |
| from which sugars | (g/kg) | 12.1 | 8.4 | <5.0 | <5.0 |
| Fructose | (g/kg) | <1.0 | <1.0 | <1.0 | <1.0 |
| Galactose | (g/kg) | <1.0 | <1.0 | <1.0 | <1.0 |
| Glucose | (g/kg) | <1.0 | <1.0 | <1.0 | <1.0 |
| Lactose | (g/kg) | <1.0 | <1.0 | <1.0 | <1.0 |
| Maltose | (g/kg) | <1.0 | <1.0 | <1.0 | <1.0 |
| Saccharose | (g/kg) | 12.1 | 8.4 | <1.0 | <1.0 |
| TGA | (ppm) | 72 | — | — | — |

### Methodology

For the raw materials as well as for the extruded products, the following chemical analyses were applied. Textural analysis was only performed for the extruded products.

### Protein Content

Protein content was determined by Kjeldahl analysis using a correction factor of 6.25. This method is based on Regulation (EC) No. 152/2009, Annex III, Method C, dairy equivalent to NEN-EN-ISO 8968-1.

### Lipid Analysis

The quantity of lipids was determined by Soxhlet extraction after acid hydrolysis, using petroleum ether and gravimetric detection (according to EC 152-2009, Annex III, method H, sub-method B).

### Crude Fibre

The quantity of crude fibre was determined by acid and alkaline hydrolysis conform to AOAC 991.43 based on EC regulation Nr. 152/2009, Annex III, Method I.

### Carbohydrates

The quantity of carbohydrates was determined by submitting the sample to an acid hydrolysis step that converts polysaccharides into free sugars and determining the amount of sugars by HPLC using a pulsed amperometric detector (PAD). Total carbohydrates are expressed as the weight total of fructose, galactose and glucose after acid hydrolysis. Free sugars are determined by HPLC analysis from an aqueous extract without acid hydrolysis; free sugars include fructose, galactose, glucose, lactose, maltose, and saccharose.

### TGA

Total glycoalkaloids (TGA) was determined by AOAC Official method 997.13.

### Fibrosity

Extruded samples were hydrated by submerging in water for 10-15 minutes, and subsequent draining on a sieve for 10-15 minutes. Test samples were selected from the hydrated extruded samples to have uniform size and shape; the size range studied was 3-5 cm. Hydrated test samples were protected against dehydration when not undergoing active treatment.

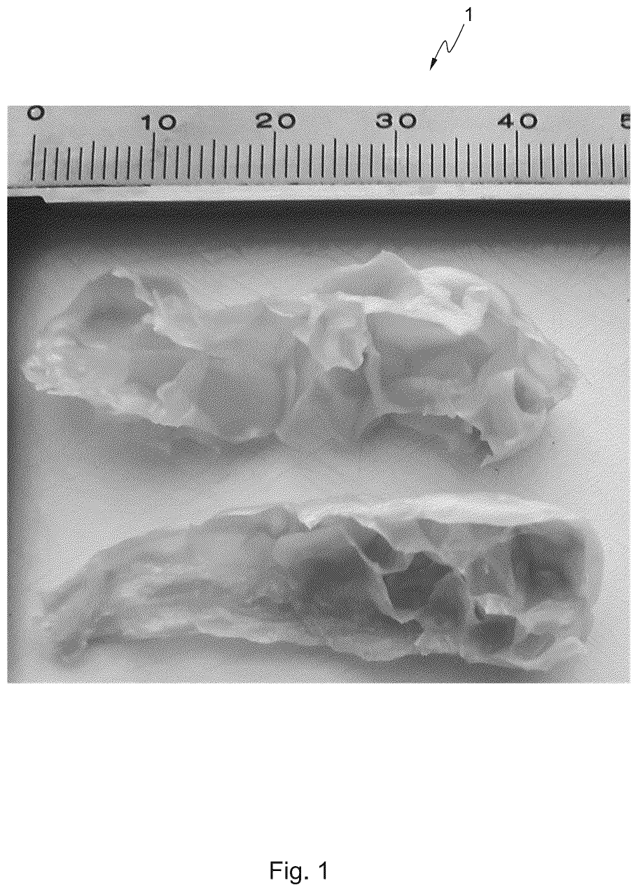

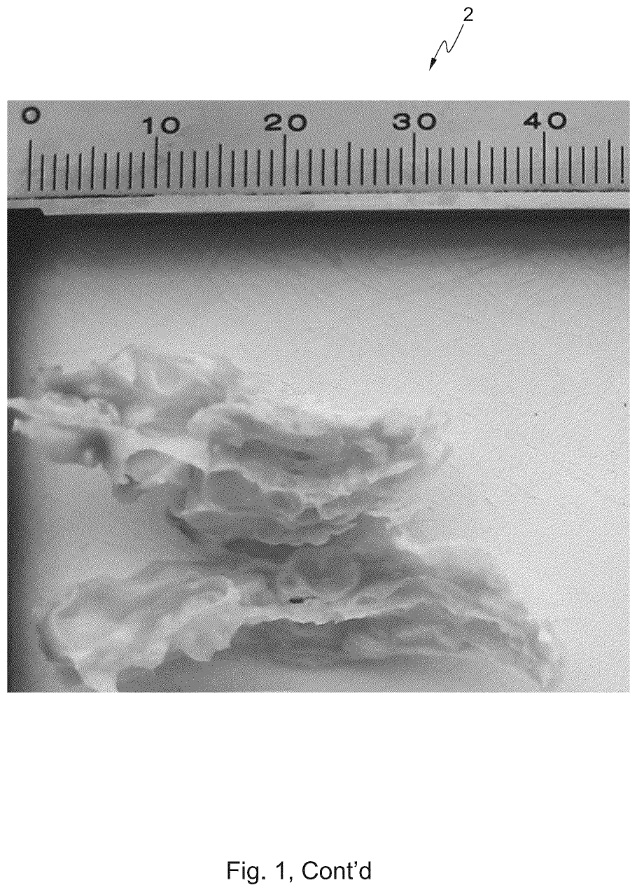

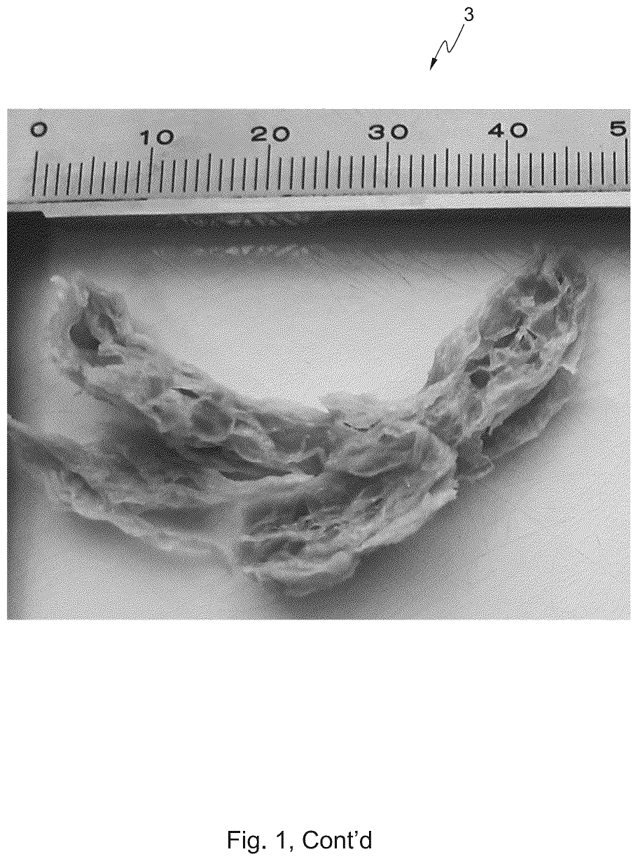

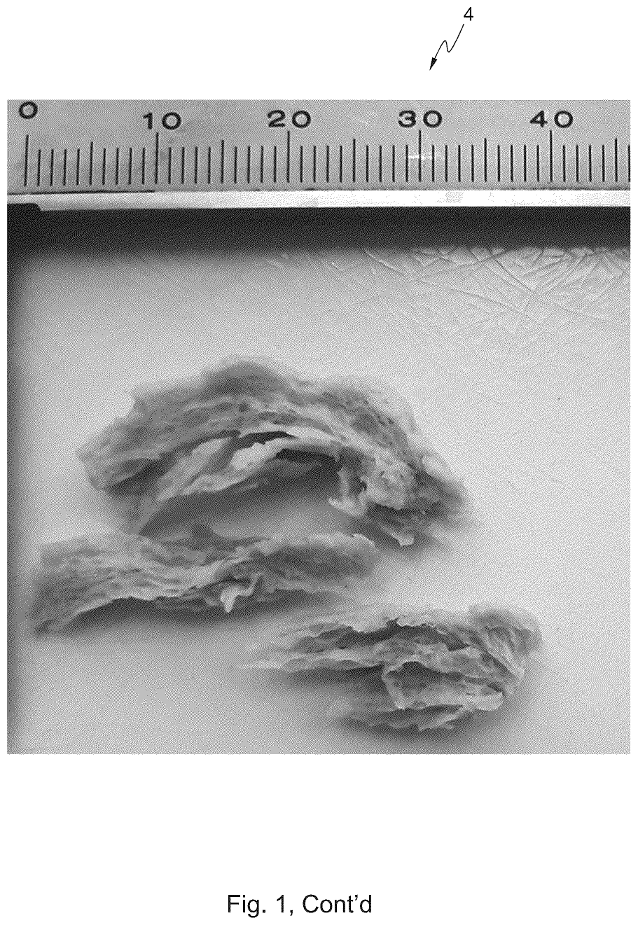

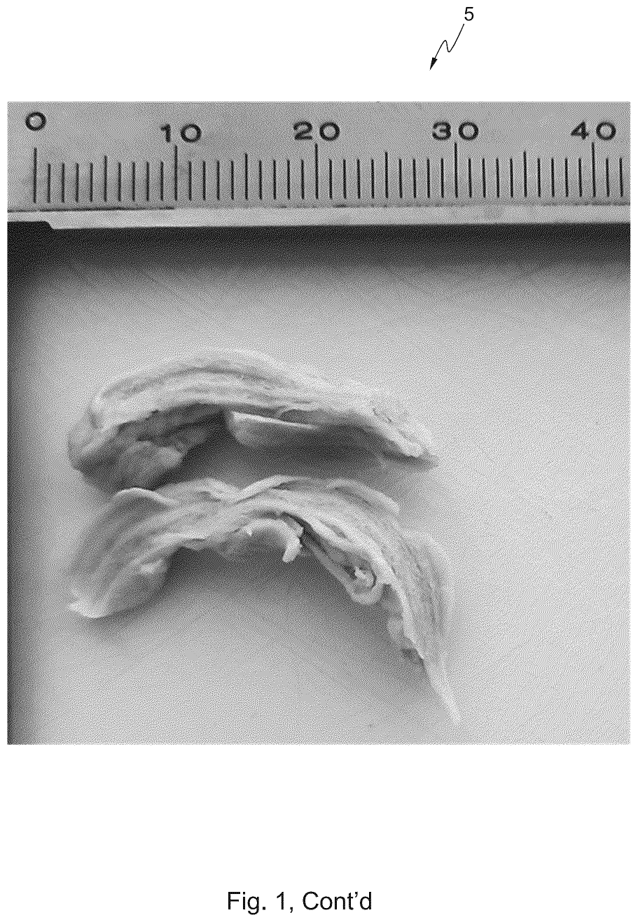

The hydrated test samples were assessed for fibrosity using a visual scale ranging from 1-5. The rating “1” represents an open non-fibrous structure (“honeycomb”), whereas the rating “5” represents a highly fibrous structure (absence of “honeycomb” structures and high fibrosity). The fibrosity scoring scale depicting fibrosity levels 1-5 is shown as FIG. 1.

### Firmness

Firmness was determined using the Warner Bratzler method, applying a texture analyser (Shimadzu EZ test EZ-SX). Hydration and selection of samples has been done as described for fibrosity. Prior to assessment, the sample diameter was measured.

Samples were placed in the centre of the sample holder, paying attention that the Warner Bratzler knife is oriented perpendicular to the fibre direction (if a fibre direction can be observed). The samples were completely cut by moving the Warner Bratzler knife down for 40 mm, making sure the knife moves completely through the plateau. Measurement speed was set at 4 mm/sec.

The peak force, expressed in Newton, was recorded and used to express absolute firmness. By dividing the firmness in N by the diameter, the relative firmness expressed in N/mm can be calculated. Each trial point was measured in 6-fold and the average number is reported.

### Extrusion

Extrusion trials were performed with a Coperion ZSK 27 twin-screw, co-rotating extruder. The ZSK 27 extruder is a food-grade laboratory scale machine (27 mm diameter). The extruder has three peripherals attached to it: water pump feeder (Feeder 1), solid material feeder (Feeder 2) and a pelletizer provided with a compressed air outlet.

The extruder barrel is composed of 6 modular blocks having a total length of 24D (4D×6). The diameter D of the screws is 27 mm. The barrel section, and thus the screws, have a total length of 648 mm. The die plate used has two conical cavities. The two conical cavities end into the two cylindrical die holes (“outlet orifices”) having a diameter of 3 mm and a length of 2 mm.

A screw configuration was used having a series of seven reversed pitch elements intertwined with conveying elements. The reversed pitch elements were placed towards the end of the screw starting at position 14 D. The reversed pitch elements were followed by a kneading block (45° stagger angle) at position 21.5 D and a conveying element right before the screw tip at position 23 D. The screw speed was 500 rpm in all experiments.

The temperature profile was based on a rather steep temperature increase after the water dosing point (2nd block). The temperature in the third (60° C.) and fourth (90° C.) blocks was set to 60 to 90° C. Higher temperatures were reached within the fifth (140° C.) and sixth (160° C.) blocks to further reduce the viscosity of the melt and facilitate the protein cleavage produced by the series of reversed pitches.

The high temperature at the die results in sudden release of water in the form of steam when exiting the extruder. The steam release resulted in a clear expansion of the extrudate. Without being bound to any theory, it is hypothesized that rearrangement and formation of protein-protein bonds when exiting the extruder result in a protein-fibrous structure.

TABLE 2
Temperature profile set in the barrel used for extrusion

| Barrel | 1 | 2 | 3 | 4 | 5 | 6 |
|---|---|---|---|---|---|---|
| ° C. | RT | 30 | 60 | 90 | 140 | 160 |

### Example 1

Pea protein isolate, potato protein isolate, as well as various pea/potato protein mixtures were extruded following the general extrusion setup described above, under different low moisture conditions. For comparative reasons, a series of pea protein/pea fibre (state of the art) was prepared following the same methods. The ratio of the mixtures is on total weight of the raw materials (“asis”).

A compositional analysis of the extruded protein products is displayed in table 3.

TABLE 3
Compositional analysis (g/kg dry matter unless
otherwise noted) of extruded products

| | 100 | 73 pea | 75 pea | 90 pea | 95 pea | 100 | 75 faba |
|---|---|---|---|---|---|---|---|
| Sample name | potato | 27 fibre | 25 potato | 10 potato | 5 potato | pea | 25 potato |
| Moisture | 103 | 132 | 96 | 100 | 113 | 124 | 73 |
| content | | | | | | | |
| Total protein | 827.2 | 629.0 | 826.3 | 834.4 | 837.7 | 836.8 | 904.0 |
| Total fat | 45.7 | 65.7 | 83.0 | 87.8 | 87.9 | 91.3 | 75.5 |
| Crude fibre | — | 6.9 | — | — | — | — | 3.2 |
| Total | 11.1 | 160.1 | 33.5 | 31.7 | 33.1 | 35.0 | 6.1 |
| Carbohydrates | | | | | | | |
| from which | <5.0 | 8.8 | 6.6 | 8.1 | 8.7 | 9.4 | <5.0 |
| sugars | | | | | | | |
| Fructose | <1.0 | <1.0 | <1.0 | <1.0 | <1.0 | <1.0 | <1.0 |
| Galactose | <1.0 | <1.0 | <1.0 | <1.0 | <1.0 | <1.0 | <1.0 |
| Glucose | <1.0 | <1.0 | <1.0 | <1.0 | <1.0 | <1.0 | <1.0 |
| Lactose | <1.0 | <1.0 | <1.0 | <1.0 | <1.0 | <1.0 | <1.0 |
| Maltose | <1.0 | <1.0 | <1.0 | <1.0 | <1.0 | <1.0 | <1.0 |
| Saccharose | <1.0 | 8.8 | 6.6 | 8.1 | 8.7 | 9.4 | <1.0 |
| TGA [ppm] | 54 | — | <30 | <30 | <30 | — | <30 |

pea = pea protein; fibre = pea fibre; potato = potato protein, faba = faba bean protein (20% MC).
Numbers in the heading represent wt. % in the feed.

The extrusion parameters and the textural analysis of the extruded products is displayed in table 4. The results show that despite neither pea protein nor potato protein providing for acceptable fibrosity under the applied extrusion conditions, mixtures of pea protein and potato protein do provide fibrous structures. Extruded mixtures of pea protein and potato protein have an acceptable firmness, and in addition provide for high protein contents.

TABLE 4
Extrusion parameters and results of the visual and textural analysis

| | | Extrusion parameters | | | | | | TVP analysis | | | | |
|---|---|---|---|---|---|---|---|---|---|---|---|---|
| | Composition | Moisture | Torque | P | T | SME | Throughput | Protein | | A. firm. | Thickness | R. firm. |
| Nr | wt. % in feed | (%) | (%) | (bar) | (° C.) | (kWh/kg) | (kg/h) | (% DM) | Fibrosity | (N) | (mm) | (N/mm) |
| Ref 1 | 73 pea/27 fibre | 26 | 27 | 25 | 169 | 0.191 | 15 | 62.6 | 2 | 7.7 | 7.1 | 1.08 |
| Ref 2 | 73 pea/27 fibre | 24 | 29 | 27 | 174 | 0.203 | 15 | 62.6 | 5 | 5.5 | 5.9 | 0.93 |
| Ref 3 | 73 pea/27 fibre | 22 | 30 | 29 | 177 | 0.216 | 15 | 62.6 | 1 | 5.5 | 5.9 | 0.93 |
| Ref 4 | 100 pea | 26 | 23 | 19 | 163 | 0.162 | 15 | 82.5 | 1 | 11.1 | 10.3 | 1.08 |
| Ref 5 | 100 pea | 24 | 25 | 13 | 164 | 0.172 | 15 | 82.5 | 1 | 10.2 | 11.9 | 0.85 |
| Inv 1 | 95 pea/5 potato | 26 | 24 | 24 | 158 | 0.168 | 15 | 82.5 | 2 | 11.6 | 10.0 | 1.16 |
| Inv 2 | 95 pea/5 potato | 24 | 25 | 33 | 163 | 0.181 | 15 | 82.5 | 3 | 10.5 | 11.0 | 0.95 |
| Inv 3 | 95 pea/5 potato | 22 | 26 | 27 | 164 | 0.175 | 15 | 82.5 | 4 | 9.7 | 8.0 | 1.21 |
| Inv 4 | 90 pea/10 potato | 26 | 24 | 24 | 166 | 0.168 | 15 | 82.5 | 3 | 11.4 | 8.5 | 1.35 |
| Inv 5 | 90 pea/10 potato | 24 | 25 | 26 | 165 | 0.182 | 15 | 82.5 | 4 | 11.2 | 8.3 | 1.36 |
| Inv 6 | 90 pea/10 potato | 22 | 28 | 27 | 168 | 0.189 | 15 | 82.5 | 5 | 9.0 | 7.6 | 1.19 |
| Inv 7 | 75 pea/25 potato | 28 | 24 | 24 | 168 | 0.174 | 15 | 82.5 | 3 | 13.6 | 7.7 | 1.77 |
| Inv 8 | 75 pea/25 potato | 24 | 28 | 26 | 169 | 0.196 | 15 | 82.5 | 3 | 11.2 | 7.9 | 1.42 |
| Inv 9 | 75 pea/25 potato | 22 | 30 | 29 | 172 | 0.203 | 15 | 82.5 | 5 | 9.1 | 7.7 | 1.18 |
| Ref 6 | 100 potato | 30 | 26 | 36 | 174 | 0.182 | 15 | 82.4 | 1 | 26.9 | 8.4 | 3.20 |
| Ref 7 | 100 potato | 28 | 31 | 25 | 175 | 0.217 | 15 | 82.4 | 1 | 19.8 | 9.4 | 2.10 |
| Ref 8 | 100 potato | 26 | 33 | 27 | 173 | 0.238 | 15 | 82.4 | 1 | 14.1 | 8.7 | 1.62 |
| Ref 9 | 100 potato | 24 | 36 | 34 | 173 | 0.251 | 15 | 82.4 | 1 | 11.8 | 8.7 | 1.36 |

pea = pea protein; fibre = pea fibre; potato = potato protein; P = die pressure; T = temperature; SME = specific mechanical energy; protein = protein content; A. firm. = absolute firmness; R. firm. = relative firmness.

### Example 2

In order to mimic scaling up of the extrusion, trials were conducted at a throughput of 25 kg/h at 500 rpm using the same screw configuration as in Example 1. Pure pea protein, as well as various pea/potato protein mixtures were extruded following the general extrusion setup described above, under various low moisture conditions. The ratio of the mixtures is on weight of the raw materials as is. For comparative reasons, a series of pea protein/pea fibre (state of the art) was prepared following the same methods.

Table 5 shows that extruded mixtures of pea protein and potato protein have an acceptable firmness and fibrosity, and in addition provide for high protein contents. Extruded pea/fibre or pure pea protein lack either firmness or fibrosity.

TABLE 5
Extrusion parameters and results of the visual and textural analysis

| | | Moisture | Torque | P | T | SME | Throughput | Protein | | A. firm | Thickness | R. firm |
|---|---|---|---|---|---|---|---|---|---|---|---|---|
| Nr | wt. % in feed | (%) | (%) | (bar) | (° C.) | (kWh/kg) | (kg/h) | (% DM) | Fibrosity | (N) | (mm) | (N/mm) |
| Ref 10 | 73 pea/27 fibre | 26 | 33 | 28 | 166 | 0.166 | 25 | 62.6 | 4 | 7.9 | 8.3 | 0.95 |
| Ref 11 | 73 pea/27 fibre | 24 | 36 | 31 | 171 | 0.181 | 25 | 62.6 | 4 | 5.3 | 7.3 | 0.72 |
| Ref 12 | 100 pea | 26 | 31 | 33 | 161 | 0.156 | 25 | 82.5 | 1 | — | | |
| Inv 10 | 75 pea/25 potato | 26 | 32 | 30 | 168 | 0.161 | 25 | 82.5 | 3 | 13.4 | 8.4 | 1.59 |
| Inv 11 | 75 pea/25 potato | 24 | 36 | 34 | 173 | 0.176 | 25 | 82.5 | 4 | 14.1 | 8.9 | 1.59 |
| Inv 12 | 90 pea/10 potato | 24 | 32 | 35 | 171 | 0.165 | 25 | 82.5 | 4 | 11.8 | 8.3 | 1.41 |

### Example 3

The TVP samples according to the invention were applied in meat alternative of the type “raw” meat burger and compared with a state of the art TVP sample comprising pea protein and pea fibre. The samples were prepared according to the recipe provided in table 6. Prior to preparing the burger, the TVP samples were comminuted to obtain particles with size of 0.5-5 mm.

TABLE 6
Recipe for making a raw meat type
meat substitute burger (wt. ratio)

| | | A | B | C |
|---|---|---|---|---|
| | | pea/ | 90 pea/10 | 75 pea/25 |
| Step | Ingredient asis (g) | fibre | potato | potato |
| 1 | TVP sample “Ref 2” | 100 | | |
| | TVP sample “Inv 5” | | 100 | |
| | TVP sample “Inv 8” | | | 100 |
| 1 | Potato starch | 12.5 | 12.5 | 12.5 |
| 1 | Givaudan Beef Aroma | 5 | 5 | 5 |
| 1 | Onion powder | 2.5 | 2.5 | 2.5 |
| 1 | Paprika powder | 2 | 2 | 2 |
| 1 | White pepper | 1.5 | 1.5 | 1.5 |
| 1 | Beet powder | 5 | 5 | 5 |
| 1 | Caramel | 1 | 1 | 1 |
| 1 | Tomato paste | 7.5 | 7.5 | 7.5 |
| 1 | Water | 145 | 145 | 145 |
| 2 | Cold Water | 95.5 | 95.5 | 95.5 |
| 2 | Ice | 50 | 50 | 50 |
| 2 | Sunflower oil | 15 | 15 | 15 |
| 2 | Microcrystalline | 5 | 5 | 5 |
| | cellulose (MC) | | | |
| 3 | Potato fiber | 7.5 | 7.5 | 7.5 |
| 3 | Psyllium fiber | 5 | 5 | 5 |
| 4 | Coconut oil | 40 | 40 | 40 |
| | Total (g) | 500 | 500 | 500 |

Potato starch = native potato starch; potato fiber = paselli FP (Avebe).

### Preparation of the Meat Substitute:

1. Mix the ingredients listed in table 6 under 1 with water in a Hobart mixer (1 minute, setting 1) and hydrate for approx. 1 hour.
2. Make a 660 g emulsion from the ingredients listed in table 6 under 2 by mixing MC, cold water and ice in a Thermomixer (setting 5) until a smooth solution has been obtained and add the sunflower oil.
3. Combine the mixtures of ingredients obtained in steps 1 and 2 by mixing them for 1 minute in the Hobart mixer at setting 1.
4. Add the dry plant fibers listed under 3 in table 6 to the mixture obtained in step 3 and mix for 1 minute in the Hobart mixer at setting 1.
5. mix in the coconut oil/fat listed under 4 in table 6, cut to small pieces where necessary and mix for 1 minute in the Hobart mixer at setting 1.
6. Shape the mixture obtained in step 5 into burger patties.
   The burgers were fried in a frying pan until a core temperature of 75-80° C. Prior to frying, the burgers may be stored for one year in a freezer at −18° C.

### Sensory Testing

For the judgement of the texture and taste, the raw meat burgers were distributed over cardboard plates after frying, coded with a 3 digit number. Eight trained panellists completed the sensory evaluation.

Texture attributes tested were firmness, first bite and fibre/meat texture. Taste attributes tested were protein taste and taste intensity.

The panellists indicated their ratings for the texture and taste attributes on a 100 mm line scale from least strong (0 mm) to most strong (100 mm). After tasting each sample the panellists were asked to neutralize the tongue with tap water and by eating a piece of a cracker, before the following alternative meat burger was tested. The panellists had to swallow the raw meat burgers. Before performance of the sensory test the panellists were asked to refrain from eating and drinking anything other than water, and not to wear perfume on the test day.

### Results

Results are shown in table 7.

TABLE 7
Results from sensory testing of meat substitutes
comprising various types of TVP.

| | Texture | | | Taste | |
|---|---|---|---|---|---|
| | | | Fibre/meat | Protein | Taste |
| Burger | firmness | First bite | texture | taste | intensity |
| A | 33 | 28 | 51 | 13 | 54 |
| B | 34 | 38 | 65 | 40 | 56 |
| C | 51 | 42 | 68 | 55 | 65 |

The results show that burgers B and C, prepared from a TVP comprising pea protein and potato protein, scored better on firmness and fibrosity than the burger prepared from a state of the art pea protein/pea fiber TVP, despite the pea protein/pea fibre TVP scoring rather high on fibrosity. The low firmness of the pea protein/pea fibre TVP products is presumed to be responsible for this result.

This observation supports the conclusion that both high fibrosity and high firmness are required for a TVP product, which can be attained by low moisture extrusion of mixtures of legume protein and tuber protein, as herein disclosed.

### Example 4

Further TVP's were prepared using a different screw configuration (screw configuration 2). In addition, the source of plant protein to be combined with the tuber protein prior to extrusion was varied.

Screw configuration 2 comprised a series of five reversed pitch elements intertwined with kneading- and conveying elements. The first kneading element (45° stagger angle) was placed at position 6D and the second kneading element at position 11D (90° stagger angle). The five reversed pitch elements were placed towards the end of the screw starting at position 16D. The reversed pitch elements were followed by another kneading element (45° stagger angle) at position 21D and a conveying element right before the screw tip at position 23D.

Using screw configuration 2, the feed composition was subjected to extrusion under low moisture conditions as herein defined, using a temperature profile in the barrel section as described above, but applying higher rotation speeds in order to gain higher throughput and production efficiency.

The feed composition comprises potato protein and pea protein mixtures as used in Example 1, and also potato protein (same as above) and faba bean protein mixtures. Faba bean protein was commercially obtained from Univar (Univar 90-C-EU), and had a protein content of 93.4 wt. % on the basis of Kjeldahl analysis. The compositional analysis of the used faba bean protein is reported in table 1.

The extrusion parameters and the TVP characteristics are shown in table 8. The compositional analysis of the TVP obtained from 75 wt. % faba bean protein and 25 wt. % potato protein at 20% moisture (Inv 13 below), is reported in table 3.

The water absorption index (WAI) is a measure for the quantity of water which is adsorbed by the TVP, under standardized conditions. First, the dry weight of the TVP is determined, by correcting the weight of the TVP asis with the moisture content: m_{dry}=mₐₛᵢₛ×((100−moisture %)/100). To determine the WAI, about 10 g of TVP is weighted accurately, and submerged using a sieve in a bowl of water for 10 minutes. The sieve with the TVP is removed from the water, and allowed to drip under gravity in order to remove excess, non-adsorbed water. The soaked TVP is then weighted, and the WAI is calculated: WAI=100*(m_{soaked}−m_{dry})/m_{dry}.

WAI of the present TVP's is provided in Table 8.

TABLE 8
Extrusion parameters and results of the visual and textural analysis

| | | | | | | | | | | A. | Thick- | R. | |
|---|---|---|---|---|---|---|---|---|---|---|---|---|---|
| | | Moisture | Torque | P | rotation | SME | Throughput | Protein | | firm | ness | firm | WAI |
| | wt. % in feed | (%) | (%) | (bar) | (rpm) | (kWh/kg) | (kg/h) | (% DM) | Fibrosity | (N) | (mm) | (N/mm) | [%] |
| Ref 12 | 100 faba | 22 | No fibrous product obtained | | | | | | | | | | |
| Inv 13 | 75 faba/25 potato | 20 | 47 | 33 | 1500 | 0.185 | 80 | 90 | 4 | 21.8 | 10.1 | 2.2 | 543 |
| Inv 14 | 75 faba/25 potato | 22 | 45 | 32 | 1500 | 0.177 | 80 | 90 | 4 | 24.0 | 11.5 | 2.1 | 596 |
| Inv 15 | 75 faba/25 potato | 24 | 43 | 43 | 1500 | 0.165 | 80 | 90 | 3 | 17.7 | 11.2 | 1.6 | 541 |
| Inv. 16 | 50 pea/50 potato | 18 | 24 | 20 | 1500 | 0.189 | 40 | — | 5 | — | — | — | 474 |
| Inv. 17 | 50 pea/50 potato | 18 | 45 | 28 | 1500 | 0.173 | 80 | — | 4 | — | — | — | 470 |

1. A low-moisture extruded texturized vegetable protein, defined as a fibrous vegetable protein material obtained by extrusion at a moisture content of 18-34 wt. %, said texturized vegetable protein having a protein content of at least 70 wt. % relative to dry matter, which texturized vegetable protein is prepared by extrusion of a feed composition comprising
a) a source of plant protein from seed, cereal, algae, fruit, leaf or legume comprising at least 65 wt. % plant protein, relative to dry matter; and
b) a source of tuber protein, comprising at least 75 wt. % tuber protein, relative to dry matter.

2. The texturized vegetable protein according to claim 1, prepared from a feed composition comprising a quantity of tuber protein of 2.5-95 wt. %, relative to total protein.

3. The texturized vegetable protein according to claim 1, prepared from a feed composition comprising a quantity of tuber protein of 2.5-50 wt. %, relative to total protein.

4. The texturized vegetable protein according to claim 1, prepared from a feed composition comprising a quantity of plant protein of at least 50 wt. %, relative to total protein.

5. The texturized vegetable protein according to claim 1, prepared from a feed composition comprising a quantity of plant protein of at least 50 wt. %, relative to dry matter, and/or a quantity of tuber protein of 2.5-50 wt. %, relative to dry matter.

6. The texturized vegetable protein according to claim 1, prepared from a feed composition comprising less than 10 wt. % of plant fiber, relative to dry matter.

7. The texturized vegetable protein according to claim 1, prepared from a feed composition comprising less than 10 wt. % of crude fiber, relative to dry matter.

8. The texturized vegetable protein according to claim 1, prepared from a feed composition comprising less than 15 wt. % of carbohydrates, relative to dry matter.

9. The texturized vegetable protein according to claim 1, said texturized vegetable protein having a moisture content of 5-12 wt. %, and said texturized vegetable protein comprising, as wt. % relative to dry matter,
a) at least 75 wt. % of protein; and/or
b) less than 15 wt. % lipid; and/or
c) at least 1 wt. % lipid; and/or
d) less than 10 wt. % of plant fiber; and/or
e) less than 10 wt. % of crude fiber; and/or
f) less than 15 wt. % of carbohydrates, relative to dry matter; and/or
g) less than 150 ppm of total triglycoalkaloids (TGA).

10. The texturized vegetable protein according to claim 1, obtainable by a process comprising
a) providing a feed composition as defined in claim 1, said feed composition having a moisture content of 1-15 wt. %, relative to the total weight of the feed composition;
b) introducing the feed composition into an extruder comprising a barrel section comprising at least 3 blocks, the first block of the barrel section comprising a feed inlet adapted for feeding the feed composition into the extruder, the second block, located downstream of the first block of the barrel section, comprising a water inlet adapted for introducing water into the extruder, and one or more further downstream blocks adapted to setting the temperature along the barrel section to comprise an increasing temperature gradient, said extruder further comprising a die section located downstream of the barrel section, and one or more screw elements adapted to convey the feed composition through the barrel section to the die section;
c) extruding the feed composition at a moisture content of 18-34 wt. %, relative to the total weight of feed composition, under extrusion conditions comprising
a temperature in the barrel section of 100-250° C.; and/or
a die pressure of 1.5-80 bar; and/or
a specific mechanical energy (SME) of 0.05-0.35 kWh/kg; and/or
100-1800 screw rotations per minute (rpm).

11. A method for preparing a low-moisture extruded texturized vegetable protein as defined in claim 1, comprising
a) providing a feed composition as defined in claim 1, said feed composition having a moisture content of 1-15 wt. %, relative to the total weight of the feed composition;
b) introducing the feed composition into an extruder comprising a barrel section comprising at least 3 blocks, the first block of the barrel section comprising a feed inlet adapted for feeding the feed composition into the extruder, the second block, located downstream of the first block of the barrel section, comprising a water inlet adapted for introducing water into the extruder, and one or more further downstream blocks adapted to setting the temperature along the barrel section to comprise an increasing temperature gradient, said extruder further comprising a die section located downstream of the barrel section, and one or more screw elements adapted to convey the feed composition through the barrel section to the die section;
c) extruding the feed composition at a moisture content of 18-34 wt. %, relative to the total weight of feed composition, under extrusion conditions comprising
a temperature in the barrel section of 100-250° C.; and/or
a die pressure of 1.5-80 bar; and/or
a specific mechanical energy (SME) of 0.05-0.35 kWh/kg; and/or
100-1800 screw rotations per minute (rpm).

12. A food product comprising a low-moisture extruded texturized vegetable protein as defined in claim 1.

13. The food product according to claim 12, which food product is an extended meat product, or a vegetarian or vegan meat substitute, or which food product is a vegetarian or vegan meal component.

14. A method for making a vegetarian or vegan meat substitute as defined in claim 13, comprising,
a) hydrating a low-moisture extruded texturized vegetable protein as defined in claim 1;
b) combining hydrated TVP with one or more ingredients selected from the group of starch, plant fiber, colorants, flavors, fats, oils, emulsifiers, proteins, probiotics, yeast extracts, binders, and salts, to obtain a raw mix;
c) shaping the raw mix to a desired shape.

15. A method for preparing a vegetarian or vegan meal component, or an extended meat product, comprising
providing a recipe for a food product comprising animal-derived meat, said recipe comprising one or more cooking steps;
executing the cooking steps in the indicated order,
wherein the execution of the cooking steps comprises substituting at least part of the animal-derived meat for a low-moisture extruded texturized vegetable protein as defined in claim 1.

16. Use of a low-moisture extruded texturized vegetable protein as defined in claim 1 as a substitute for animal-derived meat in a food product.

17.-41. (canceled)

42. The food product according to claim 13, wherein the extended meat product, vegetarian or vegan meat substitute is a burger, meat ball, skewer, nugget, sausage, minced meat, schnitzel, rib, filet, fish ball, or meat chunk, or wherein the vegetarian or vegan meal component is chili con carne, bolognese sauce, pie filling, taco filling, burrito filling, or stew.

43. (canceled)
